(19) United States
(12) Patent Application Publication
(10) Pub. No.: US 2009/0271147 A1
(43) Pub. Date: Oct. 29, 2009

(54) Pedometer

(76) Inventor: Yoshinori Sugai, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/386,844

(22) Filed: Apr. 23, 2009

(30) Foreign Application Priority Data
Apr. 28, 2008 (JP) 2008-116904

(51) Int. Cl. G01C 22/00; G06F 15/00

(52) U.S. Cl. 702/160

(57) ABSTRACT

Power savings are aimed by controlling display of a step count with no additional hardware. An acceleration sensor detects that a user is taking a step through an amplifier circuit, and outputs a walking signal corresponding to the step to a CPU. The CPU counts walking signals, and displays the accumulated number of steps on a display unit. When the CPU determines that the user is taking steps based on the walking signals, the CPU stops drive power from a battery to the display unit, and controls the display unit to stop displaying a step count.

### BACKGROUND OF THE INVENTION

1. Field of the Invention

The present invention relates to a pedometer, which detects that a user is taking steps and counts the steps.

2. Description of the Related Art

Heretofore, pedometers are utilized, one of which is mounted on the hips of a user for use, or is placed in a bag and a user carries the bag for use, and then a sensor detects that the user is taking steps for counting the steps.

Generally, because users rarely see the indications of a pedometer while walking, it is proposed that a state of closing a pedometer case cover is detected, or a state of wearing a pedometer on a garment is detected to turn out the light for the indications to provide power savings (for example, see Patent Documents, JP-A-57-48176 and JP-A-2007-307218).

However, it is necessary to provide a switch to detect the opening and closing of the pedometer case cover, or a switch to detect that the pedometer is worn on the garment, which leads to a problem of cost increases, or to the difficulties of downsizing due to additional dedicated hardware. In addition, control is necessary to detect the state of the switch, which leads to a problem of complicated configurations.

### SUMMARY OF THE INVENTION

It is an object of the invention to aim at power savings by controlling display of a step count with no additional hardware.

According to an embodiment of the invention, a pedometer is provided, which includes: a walking signal output means for detecting that a user is taking a step to output a walking signal corresponding thereto; a walking determining means for determining whether the user is taking a step based on the walking signal; a counting means for counting the walking signal; a display means for displaying thereon a step count counted by the counting means; and a control means for controlling the display means, wherein when the walking determining means determines that the user is taking steps, the control means controls the display means to stop a step count display operation.

Here, it may be configured in which in the state in which the display means stops the step count display operation, when the walking determining means determines that the user is not taking steps, the control means controls the display means to perform the step count display operation.

In addition, it may be configured in which a manipulating means is further included, and in the state in which the display means stops the step count display operation, the control means controls the display means to perform the step count display operation in response to a manipulation of the manipulating means.

In addition, it may be configured in which a battery is further included which supplies drive power to at least the display means, and the control means controls drive power supply from the battery to the display means to control the step count display operation of the display means.

In addition, it may be configured in which a setting means is further included for forcedly displaying a step count, and when the setting means makes a setting to forcedly display a step count, the control means controls the display means to perform the step count display operation, even though the walking determining means determines that the user is taking steps.

According to the pedometer of the embodiment of the invention, power savings can be aimed by controlling display of a step count with no additional hardware.

### BRIEF DESCRIPTION OF THE DRAWINGS

FIG. 1 is a block diagram depicting a pedometer according to an embodiment of the invention;

FIG. 2 is a flowchart depicting a process conducted in the pedometer according to the embodiment of the invention;

FIG. 3 is a flowchart depicting a process conducted in the pedometer according to the embodiment of the invention;

FIG. 4 is a flowchart depicting a process conducted in the pedometer according to the embodiment of the invention;

FIG. 5 is a flowchart depicting a process conducted in the pedometer according to the embodiment of the invention; and

FIG. 6 is a flowchart depicting a process conducted in the pedometer according to the embodiment of the invention.

### DESCRIPTION OF THE PREFERRED EMBODIMENT

Hereinafter, a pedometer according to an embodiment of the invention will be described with reference to the drawings. In addition, in each drawing, the same components are designated the same numerals and signs.

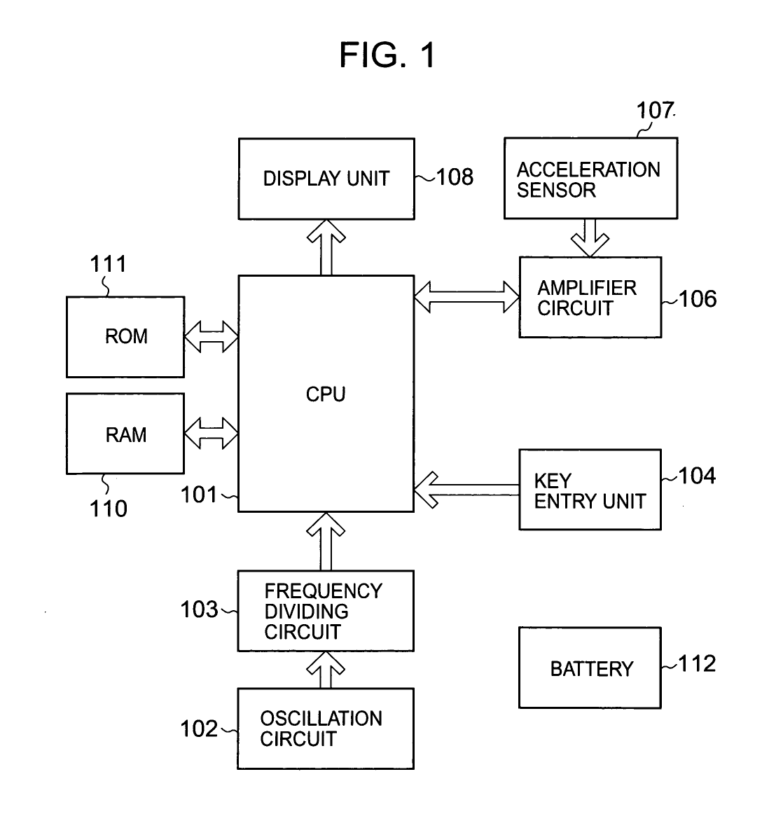

FIG. 1 is a block diagram depicting a pedometer according to an embodiment of the invention.

In FIG. 1, the pedometer has a central processing unit (CPU) 101, an oscillation circuit 102 that outputs a signal at a predetermined frequency, a frequency dividing circuit 103 that divides the output signal from the oscillation circuit 102 by a predetermined divide ratio to output a clock signal for measuring time, a key entry unit 104 configured of a switch externally operable, an acceleration sensor 107 that detects that a user is taking a step (including running) to output a signal (walking signal) corresponding to the step, and an amplifier circuit 106 that amplifies and outputs the walking signal outputted from the acceleration sensor 107.

In addition, the pedometer has a display unit 108 that displays a step count and a time of day, a random access memory (RAM) 110 that stores data of the number of counted steps and setting information, a read-only memory (ROM) 111 that stores in advance a program executed by the CPU 101, and a battery 112 as a power supply that supplies drive power to the individual components of the pedometer including the amplifier circuit 106 and the display unit 108.

In addition, the pedometer shown in FIG. 1 is an example of a portable pedometer that is mounted on the hips of a user for use, or placed in a bag and a user carries the bag for use.

The acceleration sensor 107 is a sensor configuring a walking sensor, which is configured to output an acceleration signal corresponding to the acceleration caused based on the motion such as walking as the walking signal.

Here, the acceleration sensor 107 and the amplifier circuit 106 configure a walking signal output means. The CPU 101 configures a counting means for counting steps based on the walking signals, a walking determining means for determining whether a user is taking steps based on the walking signals, and a control means for controlling a display operation of the display unit 108. In addition, the key entry unit 104 configures a manipulating means, and the display unit 108 configures a display means.

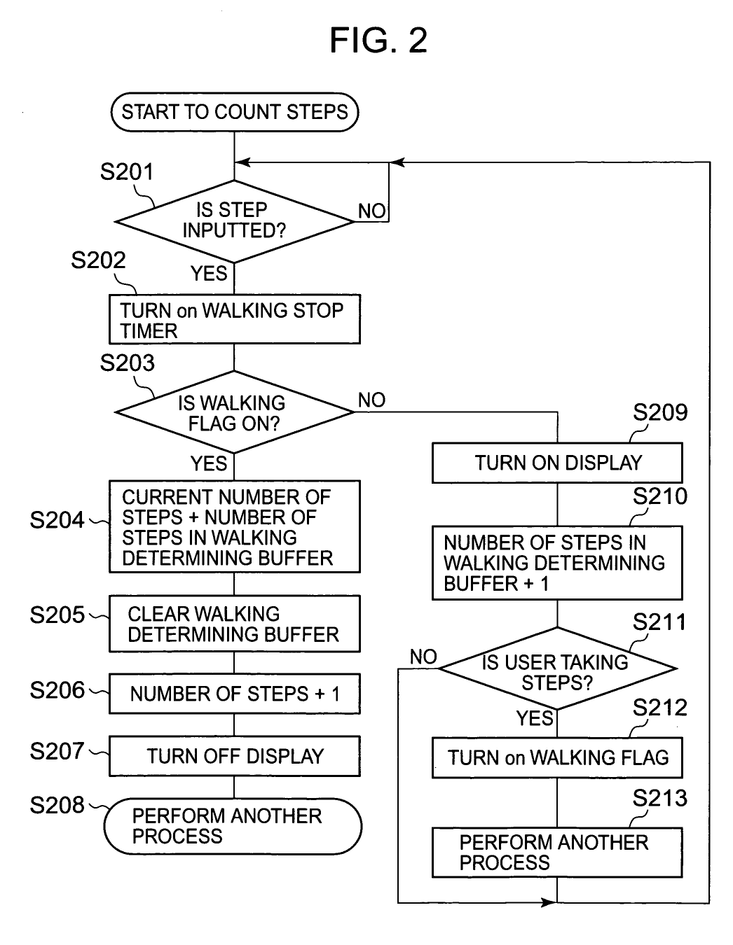

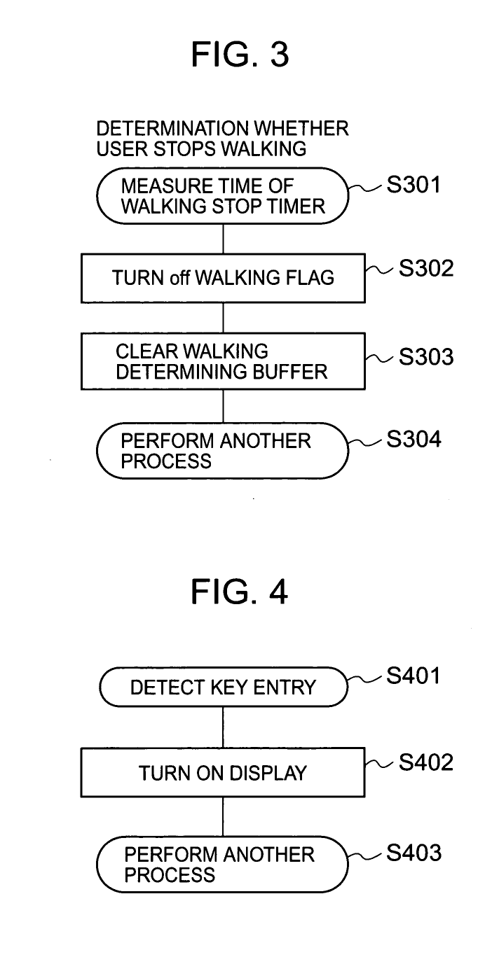

FIGS. 2 and 3 are flowcharts depicting a step counting process and a step count display process in the embodiment, showing the processes conducted by the CPU 101 executing the program stored in advance in the ROM 111.

Hereinafter, the step counting process and the step count display process of the pedometer according to the embodiment will be described with reference to FIGS. 1 to 3.

First, a user places the pedometer according to the embodiment in his/her bag, and starts to walk with the bag. The battery 112 supplies drive power to the individual circuit components of the pedometer such as the amplifier circuit 106 and the display unit 108, and these components are operating. Thus, the acceleration sensor 107 detects that the user is taking a step, and outputs a walking signal corresponding to the step to the amplifier circuit 106. The amplifier circuit 106 amplifies the walking signal outputted from the acceleration sensor 107, and outputs the signal to the CPU 101. The CPU 101 counts steps based on the walking signals from the acceleration sensor 107.

The CPU 101 determines whether the amplifier circuit 106 enters a step (that is, a walking signal is inputted) (Step S201).

If the CPU 101 determines that a walking signal is inputted, the CPU 101 turns on a walking stop timer to start to measure time (Step S202), and then determines whether a walking flag is on (Step S203).

If the CPU 101 determines that the walking flag is on (that is, the user is taking a step) in Process step S203, the CPU 101 adds the number of steps stored in a walking determining buffer (not shown) to the current number of steps (Step S204), clears the walking determining buffer (Step S205), and then adds one step taken this time to the number of steps calculated in Process step S204 to count the accumulated number of steps up to now (Step S206).

Subsequently, the CPU 101 stops drive power supply from the battery 112 to the display unit 108, and controls the display unit 108 to turn out the light to stop the step count display operation of the display unit 108 (the display is turned off) (Step S207). Because the user rarely confirms a step count by watching the pedometer while walking, there is almost no inconvenience caused by turning out the light of the display. Particularly, this tendency can be noticeably seen in the cases of pedometers mounted on the hips for use and pedometers carried in a bag. On the other hand, the light of the display is turned out, thereby exerting an advantage of aiming at power savings.

After that, the CPU 101 performs another process, if the CPU 101 is currently executing that process (Step S208).

On the other hand, in Process step S203, if the CPU 101 determines that the walking flag is not on, the user is not walking. The CPU 101 supplies drive power from the battery 112 to the display unit 108, and controls the display unit 108 to turn on the light to perform the step count display operation (the display is on) (Step S209). Therefore, the user stops walking, and then can easily confirm the step count displayed on the display unit 108.

Subsequently, the CPU 101 adds one to the number of steps in the walking determining buffer (Step S210). Subsequently, the CPU 101 determines whether the user is taking steps (Step S211). If the CPU 101 determines that the user is not taking steps, the process returns to Process step S201, whereas the CPU 101 determines that the users is taking steps, the CPU 101 turns on the walking flag (Step S212), and then performs another process if any, and the process returns to Process step S201 (Step S213).

In addition, various conditions can be set to determine whether the user is taking steps in Process step S211. For example, it may be determined that a user is taking steps when walking signals are continuously detected for a predetermined number of times. In this case, the number of steps by the time when it is determined that the user is taking steps is stored in the walking determining buffer.

Next, a process will be described when it is determined that the user stops walking. In FIG. 3, if the walking stop timer (see Process step S202 in FIG. 2) measures a predetermined time period and the time period is expired (Step S301), the CPU 101 determines that the user stops walking. The CPU 101 turns off the walking flag (Step S302), clears the number of steps stored in the walking determining buffer (Step S303), and performs another process if any (Step S304).

Next, a process will be described in which the step count display operation is currently stopped (the light of the display is turned out) and the display unit 108 then starts the step count display operation.

FIG. 4 depicts a process in which the key entry unit 104 is manipulated to forcedly switch the inactive state of the step count display operation to the active state.

In FIG. 4, when the CPU 101 detects that a key entry is. made through the key entry unit 104 in the inactive state of the step count display operation (Step S401), the CPU 101 supplies drive power from the battery 112 to the display unit 108, and controls the display unit 108 to forcedly perform the step count display operation (the display is on) (Step S402). The display unit 108 displays thereon the currently accumulated number of steps by the control. Thus, the user can confirm the number of steps by displaying a step count on the display unit 108 any time when the user desires to do so.

After that, the CPU 101 performs another process if any (Step S403).

In addition, when the key entry unit 104 is manipulated to forcedly activate the step count display operation, such a scheme may be possible to activate the step count display operation when a specific key of the key entry unit 104 is manipulated, or to activate the step count display operation when any key of the key entry unit 104 is manipulated.

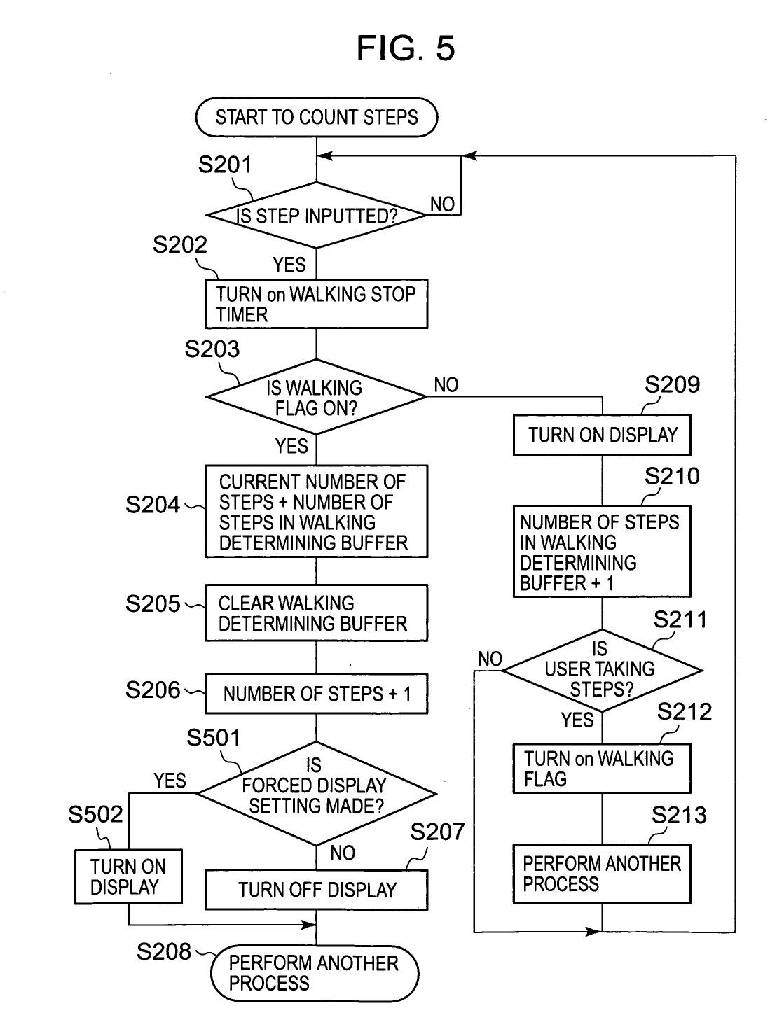

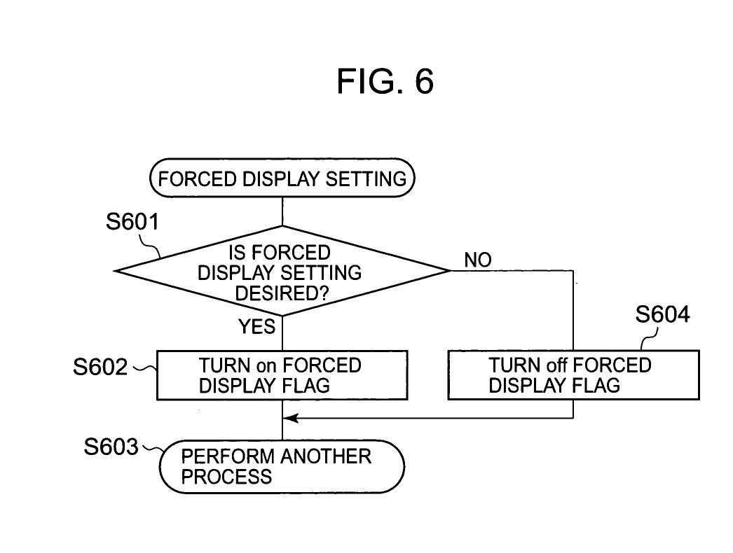

FIGS. 5 and 6 are examples in which it is configured to set in advance whether to forcedly perform the step count display operation, and the step count display operation is switched from the inactive state to the active state when it is configured to forcedly perform the step count display operation.

In FIG. 5, the CPU 101 performs the process from Process steps S201 to S206 as described above, and then determines whether a setting is made to forcedly perform the step count display operation even though the user is taking steps with reference to a forced display flag, described later (a forced display setting; the forced display flag is on) (Step S501).

If the setting is made to forcedly perform the step count display operation in Process step S501, the CPU 101 controls the display unit 108 to perform the step count display operation (the display is on) (Step S502), whereas if the setting is not made (the forced display flag is off), the CPU 101 controls the display unit 108 not to perform the step count display operation (the display is off) (Step S207). Thus, the display unit 108 is allowed to automatically display a step count.

The other process steps are the same as those in FIG. 2.

FIG. 6 is a flowchart depicting a process of the forced display setting.

When a user desires to make the forced display setting, the user manipulates the key entry unit 104 for making the forced display setting. Here, the key entry unit 104 configures a setting means.

In FIG. 6, the CPU 101 determines whether an entry is made from the key entry unit 104 to make the forced display setting (Step S601). If the CPU 101 determines that the forced display setting is made, the CPU 101 sets the forced display flag to be on (Step S602), whereas if the CPU 101 determines that the forced display setting is not made, the CPU 101 sets the forced display flag to be off (Step S604), and then performs another process if any (Step S603).

As described above, according to the pedometer of the embodiment, the acceleration sensor 107 detects that a user is taking a step, and outputs the walking signal corresponding to the step to the CPU 101 through the amplifier circuit 106. The CPU 101 counts the walking signals, and displays the accumulated number of steps on the display unit 108. When the CPU 101 determines that the user is taking steps based on the walking signals, the CPU 101 stops drive power from the battery 112 to the display unit 108, and controls the display unit 108 to stop the step count display operation.

In recent pedometers, it becomes general that a walking determining means is provided for determining whether a user is taking steps and the display of a step count is started when it is determined that the user is taking steps. When it is determined that the user is taking steps, the display of the step count is stopped to allow power savings with no additional hardware.

In addition, also in control of the step count display operation, such an advantage can be exerted that the signals from the walking determining means originally provided are used to allow power savings with less control.

In addition, in the embodiment, the pedometer of the embodiment can be utilized for various pedometers including a hip pedometer that at least a walking sensor is mounted on the hips for use, and a pedometer that at least a walking sensor is placed in a bag and a user carries the bag for use.

The pedometer according to the invention can be also utilized for a hip pedometer mounted on the hips, and a pedometer placed in a bag and carried by a user for use.

What is claimed is:

1. A pedometer comprising:
a walking signal output means for detecting that a user is taking a step to output a walking signal corresponding thereto;
a walking determining means for determining whether the user is taking a step based on the walking signal;
a counting means for counting the walking signal;
a display means for displaying thereon a step count counted by the counting means; and
a control means for controlling the display means,
wherein when the walking determining means determines that the user is taking steps, the control means controls the display means to stop a step count display operation.

2. The pedometer according to claim 1, wherein in the state in which the display means stops the step count display operation, when the walking determining means determines that the user is not taking steps, the control means controls the display means to perform the step count display operation.

3. The pedometer according to claim 1, further comprising a manipulating means,
wherein in the state in which the display means stops the step count display operation, the control means controls the display means to perform the step count display operation in response to a manipulation of the manipulating means.

4. The pedometer according to claim 2, further comprising a manipulating means,
wherein in the state in which the display means stops the step count display operation, the control means controls the display means to perform the step count display operation in response to a manipulation of the manipulating means.

5. The pedometer according to claim 1, further comprising a battery that supplies drive power to at least the display means,
wherein the control means controls drive power supply from the battery to the display means to control the step count display operation of the display means.

6. The pedometer according to claim 2, further comprising a battery that supplies drive power to at least the display means,
wherein the control means controls drive power supply from the battery to the display means to control the step count display operation of the display means.

7. The pedometer according to claim 3, further comprising a battery that supplies drive power to at least the display means,
wherein the control means controls drive power supply from the battery to the display means to control the step count display operation of the display means.

8. The pedometer according to claim 4, further comprising a battery that supplies drive power to at least the display means,
wherein the control means controls drive power supply from the battery to the display means to control the step count display operation of the display means.

9. The pedometer according to claim 1, further comprising a setting means for forcedly displaying a step count,
wherein when the setting means makes a setting to forcedly display a step count, the control means controls the display means to perform the step count display operation, even though the walking determining means determines that the user is taking steps.

10. The pedometer according to claim 2, further comprising a setting means for forcedly displaying a step count,
wherein when the setting means makes a setting to forcedly display a step count, the control means controls the display means to perform the step count display operation, even though the walking determining means determines that the user is taking steps.

11. The pedometer according to claim 3, further comprising a setting means for forcedly displaying a step count,
wherein when the setting means makes a setting to forcedly display a step count, the control means controls the display means to perform the step count display operation, even though the walking determining means determines that the user is taking steps.

12. The pedometer according to claim 4, further comprising a setting means for forcedly displaying a step count,
wherein when the setting means makes a setting to forcedly display a step count, the control means controls the display means to perform the step count display operation, even though the walking determining means determines that the user is taking steps.

13. The pedometer according to claim 5, further comprising a setting means for forcedly displaying a step count,
wherein when the setting means makes a setting to forcedly display a step count, the control means controls the display means to perform the step count display operation, even though the walking determining means determines that the user is taking steps.

14. The pedometer according to claim 6, further comprising a setting means for forcedly displaying a step count,
wherein when the setting means makes a setting to forcedly display a step count, the control means controls the display means to perform the step count display operation, even though the walking determining means determines that the user is taking steps.

15. The pedometer according to claim 7, further comprising a setting means for forcedly displaying a step count,
wherein when the setting means makes a setting to forcedly display a step count, the control means controls the display means to perform the step count display operation, even though the walking determining means determines that the user is taking steps.

16. The pedometer according to claim 8, further comprising a setting means for forcedly displaying a step count,
wherein when the setting means makes a setting to forcedly display a step count, the control means controls the display means to perform the step count display operation, even though the walking determining means determines that the user is taking steps.
